(19) United States
(12) Patent Application Publication
(10) Pub. No.: US 2009/0083214 A1
(43) Pub. Date: Mar. 26, 2009

(54) KEYWORD SEARCH OVER HEAVY-TAILED DATA AND MULTI-KEYWORD QUERIES

(75) Inventors: Arnd C. Konig, Kirkland, WA (US); Surajit Chaudhuri, Redmond, WA (US); Kenneth Church, Redmond, WA (US); Liying Sui, Mountain View, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/858,920

(22) Filed: Sep. 21, 2007

(51) Int. Cl. G06F 17/30

(52) U.S. Cl. 707/2; 707/5; 707/E17.014

(57) ABSTRACT

Index structures and query processing framework that enforces a given threshold on the overhead of computing conjunctive keyword queries. This includes a keyword processing algorithm, logic to determine which indexes to materialize, and a probabilistic approach to reducing the overhead for determining which indexes to build. The index structures leverage the fact that the frequency distribution of natural-language text follows a power law. Given a document collection, a set of indexes is proposed for materialization so that the time for intersecting keywords does not exceed a given threshold Δ. When considering the associated space requirement, the additional indexes are limited. Materialization of such a set of indexes for reasonable values of Δ (e.g., the time required to scan 20% of the largest inverted index), at least for a collection of short documents is distributed by the power law.

### BACKGROUND

At the core of Information Retrieval (IR) performance is the ability to intersect long lists of postings quickly during a query. Intersecting inverted indexes is a fundamental operation for many applications in IR and databases. Intersections of long inverted indexes are very slow relative to other queries and, unfortunately, such processes are not uncommon. Efficient indexing for this operation is known to be a difficult to accomplish for arbitrary data distributions. Some queries require costly deep traversal into long lists.

For example, such queries are part of vendor e-commerce websites with large catalogs of products that are searchable by name, description and category (e.g., “woman's shoes”, “gold jewelry”, . . . ). Some terms are more frequent than others and the higher the frequency of a keyword, the relatively longer inverted lists and the higher the intersection cost. It is important to businesses that customers can find the desired product or product information quickly. Otherwise, long latencies in searches increase the risk of consumer abandonment of the website leading to decrease in sales and advertising revenue. Therefore a few long latencies can be serious, even when the overall average may be acceptable.

A challenge is to reduce the worst-case overhead required to process arbitrary keyword queries. The database literature has studied high-dimensional indexing and partial-match queries, and found the solution to this problem to be difficult in the general case for unrestricted datasets. Determining for which keyword-combination to materialize indexes may require significant I/O and main memory. Thus, full materialization of indexes of all common phrases entails prohibitive overhead processing and storage costs. To address search performance, the IR community has developed numerous techniques aimed at reducing the amount of data that needs to be processed, by either ordering the postings within each index in a suitable manner, or by proposing approximations of the used scoring methods which may be computed more efficiently.

In the database context, various multidimensional search structures have been proposed. To apply them, each keyword query could either be formulated as a high-dimensional range query over point data or as a high-dimensional point query over heavily overlapping spatial data. Either problem formulation results in an indexing problem over very sparse data with very high dimensionality (>10 K dimensions). It is well-known that non-redundant space-partitioning techniques suffer from the “curse of dimensionality”, meaning that the access times exceed the cost of scanning the full data set for as little as ten dimensions, rendering the techniques useless.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Disclosed are index structures and a query processing framework that enforce a given threshold on the overhead of computing conjunctive keyword queries. This includes a keyword processing algorithm, logic to determine which indexes to materialize, and a probabilistic approach to reducing the overhead for determining which indexes to build.

The index structures leverage the fact that the frequency distribution of natural-language text follows a power law. In particular, it is shown that while the number of possible l-keyword combinations relevant for indexing grows exponentially with increasing l, the underlying data distribution implies that only a small fraction of these combinations is indexed, when the document sizes are small. This translates into structures that do not result in prohibitive storage costs.

More specifically, given a document collection, a set of indexes is proposed for materialization so that the time for intersecting keywords does not exceed a given threshold Δ. Where space is not an issue, all possible combinations of keywords can materialized. Thus, a challenge is considering the associated space requirement. In support thereof, the additional indexes are not larger than k times the size of the original inverted index, for a small factor of k. It is shown how to materialize such a set of indexes for reasonable values of Δ (e.g., the time required to scan 20% of the largest inverted index), at least for a collection of short documents distributed by a power law.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented system for query processing.

FIG. 2 illustrates an exemplary main index structure for multi-keyword queries.

FIG. 3 illustrates a graph indicating that only words of frequency greater than δ_{match} can occur multiple times in a single match-list entry.

FIG. 4 illustrates a method of processing a query.

FIG. 5 illustrates an alternative method of query processing.

FIG. 6 illustrates a method of creating an index structure.

FIG. 7 illustrates a method of estimating the size of an intersection.

FIG. 8 illustrates a block diagram of a computing system operable to execute multi-keyword queries according to the disclosed architecture.

### DETAILED DESCRIPTION

Intersecting inverted indexes is an operation for many applications in Information Retrieval (IR) and databases. Efficient indexing for this operation is known to be a difficult problem to solve for arbitrary data distributions. However, text corpora used in IR applications often have convenient power-law constraints (also known as Zipf's Law and long tails) that allow the materialization of carefully chosen combinations of multi-keyword indexes, which significantly improve worst-case performance without requiring excessive storage. These multi-keyword indexes limit the number of postings accessed when computing arbitrary index intersections.

Disclosed herein is a multi-dimensional index structure that improves latencies for intersecting postings. In the general case, multi-dimensional indexes consume exponential space, which is prohibitive. However, there are cases that include many of the collections of interest to the IR community, where multi-dimensional indexes are more promising, especially when appropriate care is taken in deciding which indexes to materialize.

A cost model is described for determining what to materialize. The cost model, in conjunction with various power-law assumptions, uses a triage process where keywords are assigned to three tiers based on document frequency. The most frequent words use extensive indexing. There are more words in the middle tier, at most one of which can occur in a query for which the result is materialized. The vast majority of keywords are assigned to the low frequency tier. No additional indexes beyond standard inverted indexes are required for these low frequency keywords.

One evaluation on an e-commerce collection of twenty-million products shows that the indexes of up to four arbitrary keywords can be intersected while accessing less than 20% of the postings in the largest single-keyword index.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

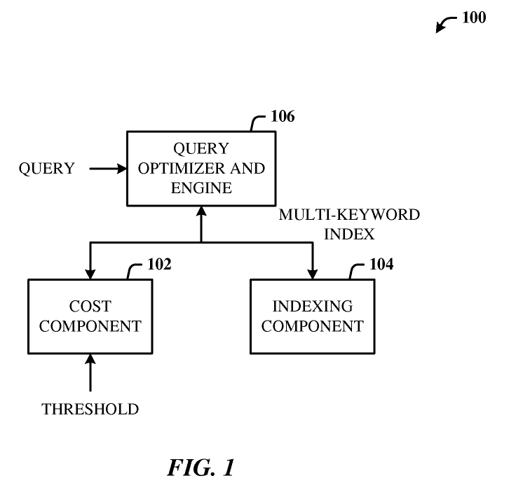

FIG. 1 illustrates a computer-implemented system 100 for query processing. The system 100 includes a cost component 102 for computing a cost associated with processing a query, the cost computed relative to a threshold. The system 100 also includes an indexing component 104 for materializing a multi-keyword index structure when the cost exceeds the threshold. The cost component 102 and indexing component 104 work in cooperation with a query optimizer and execution engine 106 to process the query in an information retrieval system.

The cost component 102 computes a cost based on a threshold value. A set of indexes is proposed for materialization such that the time for intersecting keywords does not exceed the threshold. The threshold can be set statically set according to the storage space in chip memory and/or drive memory, for example. If the index takes more space, the threshold can be adjusted upwards to allow the additional space. In another embodiment, the threshold can be based on other criteria, and could also be adjusted dynamically in suitably capable systems.

The materialization and use of the multi-keyword indexes occurs for expensive and long lists. If the computed cost indicates that the query is expensive, then multi-keyword combinations are indexed. Thus, the use of multi-keyword indexes provides a worst-case guarantee on the time it takes to execute a query. Otherwise, query processing defaults to a conventional mechanism for handling a single word query.

The following description is for system setup and notation. For each query Q, the keywords contained in the query Q are denoted by words (Q)={w₁, . . . ,wₗ}. In the following, only queries containing up to a threshold kₘₐₓ of keywords (e.g., seven keywords) are considered. Each of these keywords comes from a global vocabulary V. Note that the maximum number of keywords in a single query to consider for searches in the e-commerce scenario is small; it is well-known that most search queries are short (e.g., two to three terms).

For all keywords a global ordering π is maintained. This ordering is used for indexing; when materializing a keyword-combination C containing the words {w₁, . . . ,wₗ}, let i₁, . . . , iₗε{1, . . . ,l} be a set of indices such that ∀jε1, . . . l−1:wᵢ_{ⱼ}<_{π}wᵢ_{ⱼ₊₁}, with <_{π} denoting the ordering induced by 90 and write C as (wᵢ_{₁}, . . . ,wᵢ_{ₗ}) instead. This ensures that permutations of the same keyword-combination are never distinguished.

In the following, a query Q and the set of keywords words(Q) are used interchangeably, with the correct meaning being clear from the context of use. The number of items (=documents) whose text contains all keywords of a query Q is denoted by size(Q); similarly, for a single keyword w the number of documents containing w is denoted by size(w). Finally, the notation |Q| is used to denote the number of keywords a query Q contains.

To build structures that reduce the maximum latency of keyword queries, a simple cost model is introduced to quantify these latencies. The overall cost is expressed as a linear combination of two costs: (1) disk seeks to the beginning of posting lists, and (2) scanning the postings in the posting lists. Computational costs have decreased dramatically over time and will continue to do so going forward. However, some costs have decreased more than others. Scanning costs are dropping faster than seek costs. This trend is likely to continue going forward.

For ease of exposition, normalize the costs so that scanning a single posting in an inverted index has unit cost. This normalization allows the consideration of threshold Δ as specifying both a cost bound as well as a maximum number of postings that can be scanned.

The cost model assumes only the simplest possible IR-engine, which computes intersections by fully scanning the inverted index of every keyword. However, the disclosed framework is equally applicable to more sophisticated engines and hardware configurations (which in turn would lead to different cost models), in particular, the case in which the all inverted indexes are read and intersected in parallel (allowing the intersection of the indexes for keywords (w₁), . . . ,(wₖ) in O(maxᵢ₌₁, . . . ,ₖ size(wᵢ))) or for engines allowing random access within the indexes (allowing the intersection of two indexes of size n, m, with n<m in O(n·log₂m) operations). In both cases, fewer keyword-combinations are indexed, which in turn reduces the size of materialized structures significantly.

The cost of a query Q depends on the execution strategy chosen. There are at least two access strategies considered. A first strategy, ID-intersection retrieves all inverted indexes of the queried keywords and intersects the inverted indexes. The execution cost is modeled as |Q| seek accesses to disk (the cost of one of which is modeled as a constant Costₛₑₑₖ) to retrieve the inverted indices and the cost of reading the associated contents entirely:

$${Cost}_{Int} ( Q ) := \vert Q \vert \cdot {Cost}_{seek} + {\sum }_{w ∈ words ( Q )} \text{size} ( w )$$

A second strategy is post-filtering. If one of the keywords wᵢ in Q is very rare, Q is processed by only processing the inverted index of wᵢ, retrieving the text of all matching items, and then verifying the remaining keyword constraints using text itself. The processing costs of this strategy become independent of the number of additional keywords and the lengths of the inverted indices; however, matching the remaining keywords against the text is significantly more expensive than index-intersections for the same number of postings. Its cost is modeled as the cost to retrieve the text associated with size(wᵢ) items (which is dominated by the seek times) and applying |Q|−1 keyword-filters to the text, which is a function of the text-length for each column. For simplicity, the text length of the items is modeled as a constant length, which is multiplied by the cost of applying a single like-predicate: Cost_{Filter}. If necessary, it can be ensured that this function overestimates latency in cases with varying text-lengths by choosing this constant as sufficiently large; however, for the scenarios considered herein, the text lengths tend to be small and not vary too much; hence, the costs for this strategy tend to be dominated by the seek times:

Cost_{Probe}(wᵢ):=size(wᵢ)·(Cost_{seek+(|Q|-}1)length·Cost_{Filter}).

Given a cost model, additional indexes are now described to complement single-keyword inverted indexes which enforce an execution cost of less than a threshold Δ by limiting the maximum number of postings to retrieve for an arbitrary query. The structure utilized is additional inverted indices that materialize the postings for documents containing combinations of keywords; that is, each such index can be thought of as the materialized result to that particular keyword query. The salient features of these structures are:

(a) Only materialize indexes for a k-keyword combination if the corresponding query result can not be obtained quickly (e.g., with less than Δ/2 overhead) using intersection of inverted indexes for keyword combinations of size k′<k.

(b) Part of the query-processing time of a query is allotted to probing the “catalogue” of the materialized structures to discover which relevant keyword combinations are indexed. Information is also obtained on the size of the inverted indexes as part of this probing, allowing the subsequent choice of an execution strategy (as predicted by the cost-model) before the actual processing of the query.

(c) For a small number of keyword combinations simply retrieving the fully pre-computed answer to a search query requires more than the target latency. However—due to data skew—there will be few such instances; moreover, since these are search results, the user interface initially displays the top-ranked results (ordered by a choice of ranking scheme) and uses the time that the user is browsing the results to retrieve the remainder. Therefore, for the few such keywords or keyword-combinations, the top-ranked results are materialized separately.

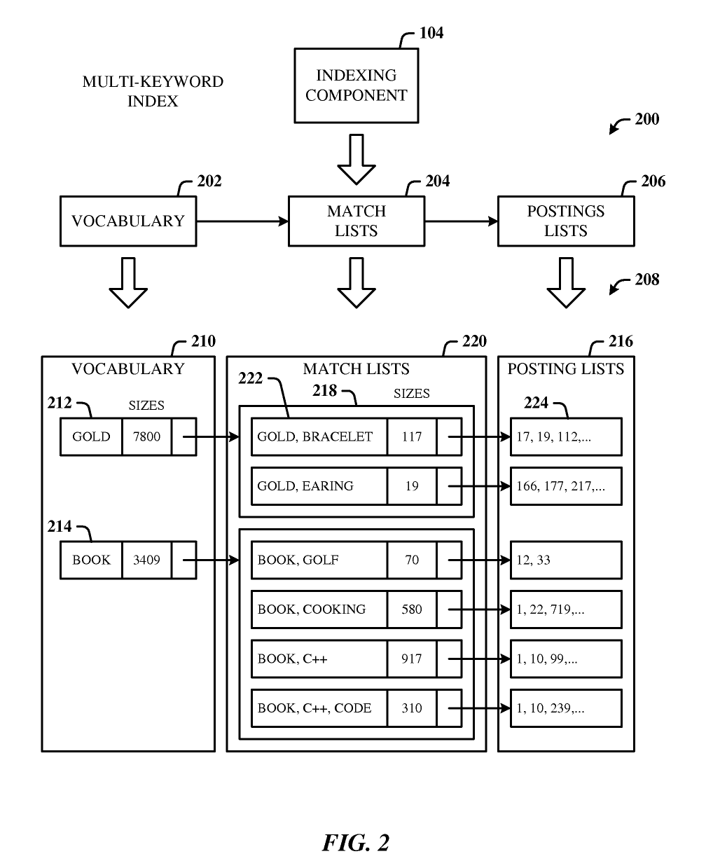

FIG. 2 illustrates an exemplary main index structure 200 for multi-keyword queries. The structure 200 is generated by the indexing component 104, and includes a vocabulary part 202, a match lists part 204, and a postings lists part 206.

The main structure 200 used to complement the inverted indexes adds one layer of indirection to the standard inverted index, the match lists part 204. An example index structure 208 is provided. A vocabulary section 210 includes two vocabulary items: a gold item 212 and a book item 214. Instead of pointers from each vocabulary item (e.g., vocabulary item 212) to the corresponding inverted index (in an example postings (or inverted) list 216), for each vocabulary item w—a list 218 of all keyword combinations containing w for which the corresponding inverted index has been materialized, is maintained (as in an exemplary match lists 220). The set of all keyword combinations realized as match list entries is denoted by Match Lists. Each entry (e.g., entry 222) in the match list 220 in turn points to an inverted index (e.g., index 224) containing postings of all items matching all keywords in the entry. In addition, each entry (e.g., entry 222) in the match list 220 also stores the number of postings in the corresponding inverted index (e.g., index 224). The number of postings in each single-keyword inverted index is also maintained together with the vocabulary.

The physical layout of this structure is as follows: since only combinations of frequent keywords are materialized, and then only a small fraction of the combinations, it is possible to maintain an index with the first two keywords of each combination in main memory. Note that if the match list grows too large, then part of this index can be written to disk, inducing one additional seek per keyword. In the following description, it is assumed for purposes of cost modeling that this layout is in place.

In operation, when a new query is received, the cost component provides the cost for how expensive the query will be. At any point of time, the number of postings for each keyword is known, thus, providing a measure of the length of the lists that are to be intersected. If the query is “cheap”, the query is processed. If the query is “expensive”, first look into the match lists 220 that are mentioned to see for which combinations of key words there are additional indexes. Next, pick from the regular indexes and the match list entries, which are the multi-keyword indexes, a subset that has two properties. The one property is the subset contains all the keywords in the search query. The keywords can be in the subset multiple times (this does not affect correctness). For example, if the query includes both “gold” and “book”, use one index on “gold”, another on “book”, and another that is on “gold” and “book”. Then by intersecting the sets to get the correct set of results. The second property is that the set has the minimum number of postings, which means the minimum aggregated listings. Thus, the cheapest combinations of indexes are picked to execute the query among all the lists available and these are the lists to intersect.

Once this index structure is in place, a query Q is processed over keywords w₁, . . . ,wₖ as follows: if Q contains a keyword wᵢ sufficiently rare so that the post-filtering strategy becomes sufficiently inexpensive, this strategy is used. Otherwise, all match-list entries containing two keywords from Q as the prefix are retrieved (it is assumed that the single-keyword vocabulary and sizes are already memory-resident). Using the size-information contained in the match-list entries it can now be determined if size(Q) is sufficiently large that Q cannot be processed entirely without violating the cost-threshold Δ; if this is the case, the top-ranked tuples are retrieved from the corresponding index. For queries with smaller result sizes, the combination of inverted indexes which covers all keywords in Q (possibly more than once) while minimizing the cost (using our cost model) of intersecting these indexes is now determined. Note that this covers both multi- and single-keyword inverted indexes. This formulation results in an optimization problem,

$${Cost}_{Opt} ( Q ) := {min}_{C ⊆ v ⋃ Match : \\ ⋃ C = words ( Q )} {\sum }_{c ∈ C} {Cost}_{Seek} + \text{size} ( c ) , \qquad ( 1 )$$

which is a variant of a set cover problem; however, an exact solution is not required, but only an approximation as long as two properties are fulfilled:

(A) The algorithm considers—when it chooses a set of inverted indexes to process a query Q over words(Q)={w₁, . . . ,wₖ} (among other alternatives) the execution plan formed by intersecting the (sets of) inverted indexes used when processing the queries formed by the keyword sets S₁ and S₂ constructed as follows: let w₁^{f}, w₂^{ƒ}be the two most frequent (occurring most often in the corpus) keywords in words(Q) (ties are broken using the ordering π); now let S₁, S₂ be defined as S₁=words(Q)−{w₁^{f}},S₂=words(Q)−{w₂^{f}.}

(B) The algorithm considers intersecting the (sets of) inverted indexes used when processing the queries formed by the keyword sets C₁, and C₂ constructed as follows: let w₁^{l} and w₂^{l} be the least frequent keywords among words(Q) (ties are broken using the ordering π); now let C₁, C₂ be any two sets for which C₁∪C₂=words(Q),C₁∩C₂=Ø and w₁^{l}εC₁w₂^{l}εC₂.

The relevance of these properties is illustrated herein below. Hereinafter, the set of inverted indexes this algorithm selects when processing a query C is denoted as index(C); in particular, for any word w, index(w) refers to the “standard” inverted index for a single keyword w. Similarly, the cost of the solution provided by the algorithm employed is referred to as Cost_{Opt}(Q).

Once a suitable combination of inverted indices has been determined, the query result is computed by retrieving the inverted indexes in the inverse order of size and then intersecting the indexes. The total cost of this execution plan is the cost of retrieving all relevant match list entries and the cost of retrieving and intersecting the selected inverted indexes (=Cost_{Opt}(Q)). The cost for retrieving the match list entries is dominated by the number of disk seeks used, so the disk seeks alone are used to model this cost. For a k-keyword query up to (k₂^{k}) entries in the match lists are examined; given that the number of keywords in a query is small, this number of seeks can be upper-bounded by the number of keywords multiplied with a small constant (e.g., for kₘₐₓ=5, the bound is 3k). The minimum latency “available” after all relevant match-lists entries have been read is defined as Δ′=Δ−(₂^{k}^{ₘₐₓ})Cost_{Seek·}Thus, in order to ensure the overall latency threshold Δ, additional indexes are materialized ensuring that Cost_{Opt}(Q)≦Δ′.

This also means that for any query Q with size(Q)>Δ′−Cost_{Seek} the top-ranked tuples may need to be explicitly materialized, as the query cannot be processed with a larger result under the latency-threshold.

With respect to modeling the index size, the following description begins with a general overview of the properties of large corpora that are relevant to this problem setting and show the properties to be present in a variety of real-life datasets. The combinations of keywords for which match list entries and posting lists will be materialized is described, followed by showing how to use the properties of the underlying corpora to model the size resulting index structure.

Word frequency distributions in natural language datasets have been found to be shaped according to a power law. Moreover, the same property is found to hold for the frequency distribution over multi-keyword combinations occurring in the data. These properties are leveraged by essentially performing a “triage” over keywords by assigning the keywords into three categories: (a) low-frequency keywords for which no additional indexes are materialized, (b) medium-frequency keywords where at most one of which may appear in a match list entry, and (c) a small number of high-frequency keywords for which a number of indexes are materialized. For scalability, it is ensured that the number of keywords in the latter two classes does not grow quickly with corpus size.

The following describes the structures materialized to ensure that the cost for processing a query of up to k ₘₐₓ keywords does not exceed the threshold Δ. To populate the match-lists, first, the keyword-combinations of size two are considered for materialization, and then the size is increased until kₘₐₓ keywords is reached. For any size k all combinations C are materialized for which the following conditions hold,

∀wεwords(C):Cost_{Probe}(w)>Δ, and (2)

$${Cost}_{Opt} ( C ) \geq \frac{{Δ}^{′}}{2} - {Cost}_{Seek} \\ using existing indexes , and \qquad ( 3 )$$

size(C)≦Δ′−Cost_{Seek.} (4)

The resulting structures ensure that any query Q for which it holds that size(Q)≦Δ′−Cost_{Seek} can be computed using less than threshold Δ cost. If Cost_{Opt}(Q)≧Δ′/2−Cost_{Seek} using indexes over combinations of less than |Q|−1 keywords (condition (3)) and post-filtering is not an option (condition (2)), then materialize an additional inverted index, as condition (4) holds.

To model the index sizes based on these observations, a relatively simple analytical model of the word-frequency distributions is used for ease of exposition. The main contribution of the theoretical model is to show that the potentially exponential growth of possible keyword-combinations is balanced by the power-law behavior of the word-distribution in natural language corpora.

The following notation is used: let N be the total number of words in the text distribution, and V=|V| be the number of distinct words. Due to the power-law, the frequency of a word of rank z can be expressed as,

$$f ( z ) = \frac{ζ}{{z}^{a}} N$$

where ζ is a normalizing constant smaller than one ensuring that

$${\sum }_{z = 1}^{V} f ( z ) = N$$

and α is a fitting parameter modeling the skew of the distribution. For ease of exposition, α is set equal to unity, resulting in the standard harmonic probability distribution over words. Under this distribution, the number of words that occur m times, V (m), can be modeled as,

$$V ( m ) = \frac{V}{m ( m + 1 )} . \qquad ( 5 )$$

First, it is shown how the power-law distribution and the construction lead to the “triage” of keywords. Since the cost of the post-filtering strategy only depends on the length of the text associated with items and the number of occurrences of the rarest keyword in a query, Equation (5) means that the majority of keywords will not occur in any keyword combination in the match list. Any keyword w for which,

$$\text{size} ( w ) \leq {δ}_{tail} = \frac{Δ}{( {Cost}_{seek} + ( k - 1 ) \text{lengh} \cdot {Cost}_{Filter} )}$$

cannot lead to execution costs in excess of Δ, and hence, no additional indexing is required, eliminating

$$V - \frac{ζ \cdot N}{{δ}_{tail}}$$

keywords from consideration.

Similarly, not more than one keyword w with size(w)≦δ_{match}:=(Δ′/2−Cost_{Seek}) can occur in a k-keyword entry in the match list. This can be proved by contradiction. Consider the case of such a combination being materialized. Assume a keyword-entry C comprising k keywords words(C)={w₁, . . . ,wₖ}; let w₁, w₂ be the least frequent keywords with size(w₁)≦size(w₂)<δ_{match}. The algorithm considers an execution strategy that intersects the indexes used when processing two subsets C₁, C₂ of words(Q) sharing no keywords, one of which contains w₁, and the other w₂. Therefore, either C₁ is not materialized, implying that Cost_{Opt}(C₁)<Δ′/2−Cost_{Seek}, or it is materialized, meaning it can be retrieved using cost Δ′/2. Using a similar argument for C₂, Cost_{Opt}(C) can be at most Δ′, meaning there is no need to materialize an entry C, leading to a contradiction.

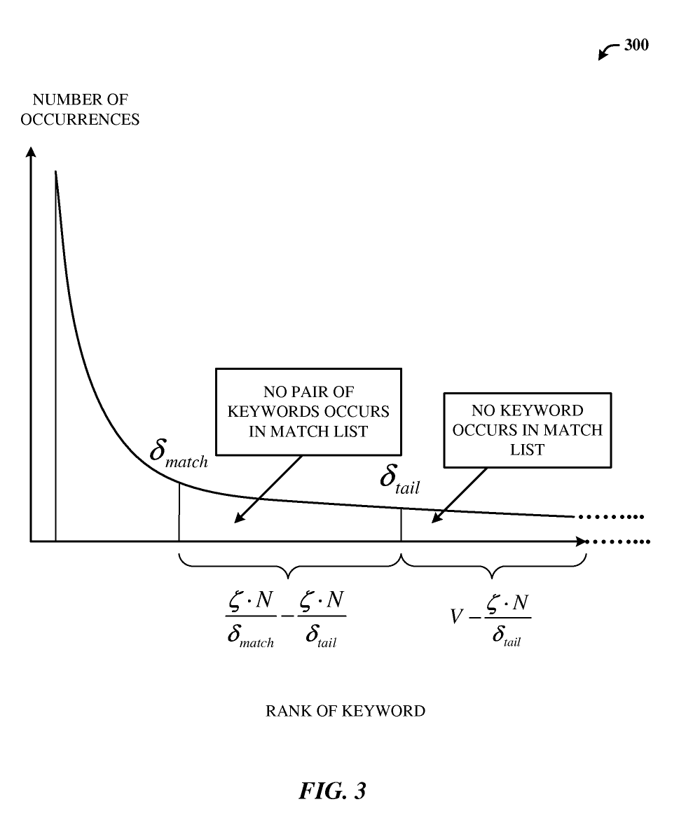

FIG. 3 illustrates a graph 300 indicating that only words of frequency greater than δ_{match} can occur multiple times in a single match-list entry.

This model is now used to model the number of l-keyword combinations that occur in more documents than a threshold χ. This value is denoted as occurrences(l,χ). Subsequently, it can be shown that the number of l-keyword entries into the match list can be modeled as a function of occurrences( . . . ). Note that in the target scenario the individual items are associated with relatively small text entries (e.g., a product, a review, or a seller), which will be shown to result in a small rate of growth for occurrences(l,χ) with increasing values of l.

First, define avg_w as the average numbers of words contained in the text associated with an item. For ease of exposition, it is assumed that all items are associated with exactly avg_w words (as opposed to modeling the distribution of this value explicitly). There are necessarily some duplicate words in an item, so the number of distinct words Vₑ(n) in a document of n words is modeled conventionally as a function of the document size:

Vₑ(n)=R·\sqrt{n},

for a constant R. Using this model any item will contain (ₗ^{R√}{square root over (avg^{_{—}}^{w})}) distinct l-keyword combinations. Under the simplifying assumption that the power-law distribution governing the l-keyword distribution follows the same skew-parameter as the original keyword distribution, the number of l-keyword combinations occurring more often than χ can be constrained as,

$$\text{occurrences} ( l , χ ) = \frac{ζ \cdot N \frac{( \begin{matrix}R \sqrt{avg\_w} \\ l\end{matrix} )}{avg\_w}}{χ}$$

This means that while the number of possible keyword-combinations grows exponentially in the number of keywords, the number of l keyword combinations larger than a threshold χ grows by a factor of

$$\frac{R \sqrt{avg\_w} - l}{l}$$

with increasing l. Here, (a) this factor is a function of the square root of the individual text sizes (which are small for the target scenarios) and independent of the corpus size or the vocabulary size (both of which can become very large in this context), and (b) the factor decreases as l grows, resulting in tractable numbers of combinations to materialize.

This immediately allows the modeling of the number of keyword combinations for which to explicitly materialize the top results, since the result-sets are too large to be read within Δ cost as

$${\sum }_{l = 2}^{{k}_{max}} \text{occurences} ( l , {Δ}^{′} - {Cost}_{Seek} ) .$$

As an example that demonstrates the size of the resulting values, consider a data distribution modeled on the product database of twenty million postings, containing N/avg_w=60·10⁶ entities; each entity contains approximately w=100 words, meaning ζ becomes ≈ 1/15 and there is a total of N·avg_w=6000 Million postings. Choose R=2.5. Assuming the indexing for queries containing up to k=5 keywords, and set χ at 50K ID-values, it follows that occurrences(3, χ)=18.4K, occurrences(4, χ)=101K and occurrences(5, χ)=425K. Even when multiplied with the number of top-ranked postings materialized for these keyword combinations, these numbers still are small fraction of the six billion postings in the original index.

Moreover, the above can be used to model a loose constraint the number of l-keyword entries in the match list, of the form f·occurrences((l-1), χ)/l. To show this, consider an arbitrary entry C={w₁, . . . ,wₗ} in the match-list; let wₘᵢₙ be the keyword in C for which size(wₘᵢₙ) is minimal, C′=words(C)−wₘᵢₙ. Now one of two conditions hold:

(a) size(C′)>δ_{match} . In this case, the only statement made about size(wₘᵢₙ) is that it is larger than δₜₐᵢₗ, meaning that there are at most

$$\underbrace{\text{occurrences} ( l - 1 , {δ}_{match} )}_{number of combinations for {C}^{′}} \cdot \underbrace{( \frac{ζ \cdot N}{{δ}_{tail}} )}_{possible values for {w}_{min}}$$

such combinations possible; or

(b) size(C′)≦δ_{match}. In this case, let S₁, S₂ be subsets of words(C) as defined above, both containing wₘᵢₙ. It is known that size(wₘᵢₙ)>δ_{match} (otherwise, C could be computed via the intersection of index(wₘᵢₙ) and index(C′) in time less than Δ′). It is also known that either size(S₁)>δ_{match} or size(S₂)>δ_{match} (again, otherwise indexing is not needed, C could be computed as the intersection of index(S₁) and index(S₂)). The number of such combinations can be no more than,

$$\underbrace{\text{occurrences} ( l - 2 , {δ}_{match} )}_{number of combinations for {S}_{1} ⋂ {S}_{2}} \cdot {\underbrace{{( \frac{ζ \cdot N}{{δ}_{tail}} )}^{2} / 2}}_{possible combimations of words ( C ) - {S}_{1} ⋂ {S}_{2}}$$

for ease of notation, occurrences(O, χ) is defined as one.

This means that with the growing number of keywords the number of entries in the match list can be expected to grow more slowly than the number of keyword-combinations occurring more often than a threshold (as δ_{match} grows linearly with l). However, depending on the value of Δ, the factors (ζ·N/δₜₐᵢₗ) or (ζ·N/δ_{match})²/2 may become very large. In these cases, techniques are applied to a subset of the most frequent keywords only (e.g., only keywords occurring in search logs).

While the above calculations allow modeling the number of keyword combinations for which additional inverted indexes are created, it does not indicate anything non-trivial about the distribution of posting-sizes of the corresponding inverted indexes. These size-distributions can be highly skewed as well. Not only does the vast majority of keyword-combinations satisfying conditions (2)-(4) above result in empty intersections (in this case, the corresponding match-list entry does not have to be materialized; using size-information stored as part of the non-empty match list entries, the execution engine can infer these cases), but most of the remaining indexes have less than ten postings.

With respect to index construction, construction of the proposed structures uses two elementary operations: (a) deciding which additional inverted indices to materialize, and (b) building and maintaining the indexes themselves. Part (a) is challenging, as it requires knowledge of the intersection sizes for very large inverted indexes, which are unlikely to fit into main memory at the same time. This may make this part of the computation prohibitively expensive.

A solution is to employ a probabilistic scheme to estimate the intersection sizes, allowing compact representations of the relevant inverted indexes to be maintained, which fit into main memory. This is made possible by the fact that the cost-thresholds are necessarily large enough to allow the retrieval of tens of thousands of postings without exceeding threshold Δ (a full-text retrieval system that cannot handle these numbers is likely a no-starter in the first place), providing some flexibility regarding the accuracy of the probabilistic techniques.

Computing the size of intersections between lists of postings corresponds to the problem of computing L₁-distances between columns in the indicator matrix A formed using the keywords as one dimension and the item/document ID values as the other. Conventional techniques for such distance computations in limited memory are based on random projections, which multiply A by an appropriately chosen random matrix R to generate a much smaller data matrix B=A·R. However, these estimation methods are typically not applicable to multi-way intersections, which are used herein. As a consequence, a conventional technique is employed based on a combination of sketches and sampling: Let ID denote the set of identifiers for all documents in the corpus. This method then uses a random permutation π_{ID}:ID [symbol] {1, . . . ,|ID|} and—for every inverted index—constructs a sample of the first (according to π_{ID}) postings in the index. Now, intersection sizes between a list of inverted indexes I₁, . . . ,Iₗ , can be estimated based on these samples, as follows: let Dₛ, be the smallest among the maximum (according to π_{ID}) postings in the respective samples. Now, trim the samples from all postings i for which π_{ID}(i)>Dₛ. The resulting samples are equivalent to a random sample of Dₛ, rows from across the respective l columns in the indicator matrix A. This sample can now be used to compute a maximum-likelihood estimate of the intersection size.

Note that the sampling ultimately only affects one condition among the three conditions (2)-(4) governing which keyword-combinations to materialize, and that is condition (4). Condition (2) depends only on the sizes of single-keyword indexes, which are stored together with the vocabulary. Moreover, since the match-list entries and the corresponding indexes are constructed in the order of the number of keywords contained (this way, existing indexes can be used, significantly reducing construction-costs), the exact sizes of all materialized multi-keyword indexes over (k−1)-keyword combinations are known when determining which indexes over k-keyword combinations to construct. This is turn means that condition (3) can also be evaluated exactly and only the size of the new index has to be estimated. Note that this means that bad estimates can never cause failure to meet the threshold Δ; just that too many indexes may be constructed.

In order to further compress the resulting structures, each posting (which in our experimental setup corresponds to a 32-bit document ID before compression) is augmented with an additional 32-bit field, which indicates the presence of certain high-frequency keywords in the document to which the posting refers. For example, this field can be used to indicate the presence or absence of one of the thirty-two most frequent non-stopwords in the corpus. In this case, the materialization of a multi-keyword index over a combination of these high-frequency words and less frequent words {w₁, . . . ,wₕ} can be avoided, as the index on {w¹, . . . ,wₕ} (which, however, may be larger) can be used to obtain the same information.

In an experiment on an e-commerce dataset, most frequent keywords correspond to distinct product categories (e.g., ‘book’) and a few frequent product attributes (‘red’, ‘black’, ‘pages’), meaning that relatively few combinations of the keywords actually co-occur in product descriptions in the corpus. This allows the encoding of all occurring combinations of significantly more than thirty-two frequent keywords in the 32-bit field. While the additional field doubles the size of each posting before compression (the encoded values are highly skewed and thus should compress well), it can significantly decrease the number of keyword-combinations materialized.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

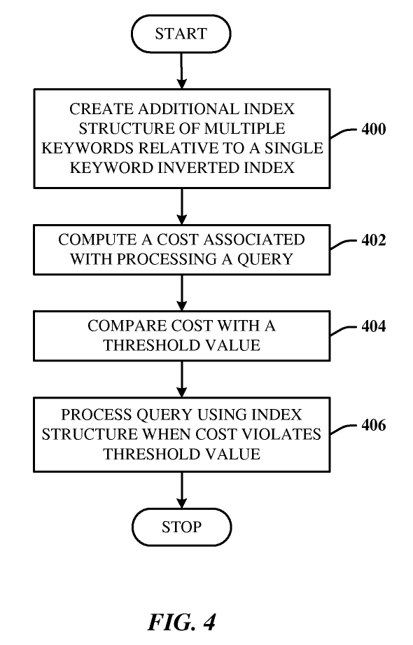

FIG. 4 illustrates a method of processing a query. At 400, an additional index structure of multiple keywords is created relative to a single keyword inverted index. At 402, a cost associated with processing a query is computed. At 404, the cost is compared to a threshold value. At 406, the query is processed using the index structure when the cost exceeds the threshold value.

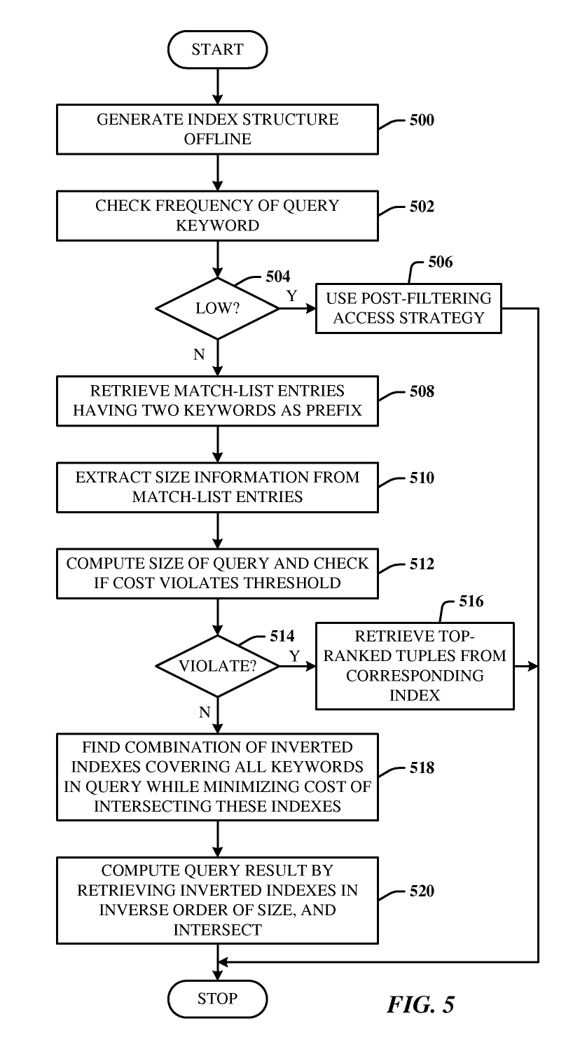

FIG. 5 illustrates an alternative method of query processing. At 500, an index structure is generated offline. At 502, the frequency of a query keyword is checked. At 504, if low, flow is to 506 to use a post-filtering access strategy. If not low, flow is from 504 to 508 to retrieve match-list entries having two keywords as prefix. At 510, the size information is extracted from the match-list entries. At 512, the size of the query is computed and a check made if the cost violates a threshold. At 514, if the cost violates the threshold, flow is to 516 to retrieve the top-ranked tuples form the corresponding index. On the other hand, if the cost does not violate the threshold, flow is from 514 to 518 to find the combination of inverted indexes that cover all the keywords in the query while minimizing the cost of intersecting these indexes. At 520, the query result is then computed by selecting the inverted indexes in inverse order of size, and then intersecting the selected indexes.

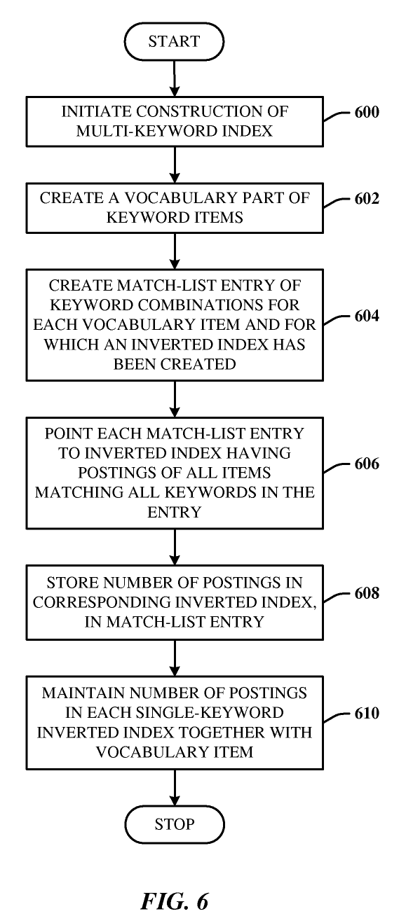

FIG. 6 illustrates a method of creating an index structure. At 600, construction of the multi-keyword index is initiated. At 602, a vocabulary part of keyword items is created. At 604, a match-list entry of keyword combinations is created for each vocabulary item and for which an inverted index has been created. At 606, each match-list entry is pointed to the inverted index having postings of all items matching all keywords in the entry. At 608, the number of postings in the corresponding inverted index is stored in the match-list entry. At 610, the number of postings is maintained in each single-keyword inverted index together with the vocabulary item.

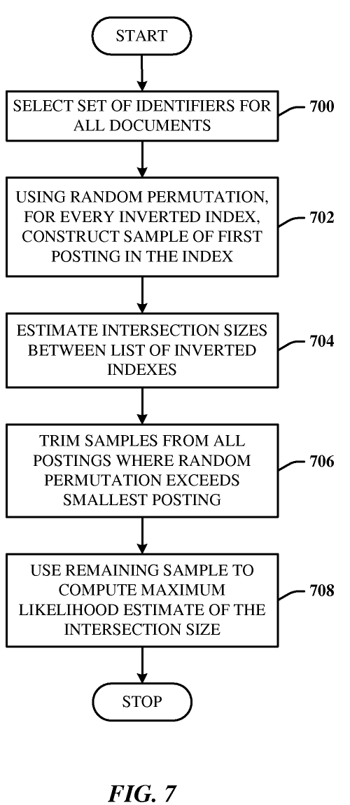

FIG. 7 illustrates a method of estimating the size of an intersection. At 700, a set of identifiers for all documents is selected. At 702, using a random permutation, for every inverted index, a sample is constructed of the first postings in the index. At 704, the intersection sizes between the list of inverted indexes is estimated. At 706, samples from all postings where the random permutation exceeds the smallest posting, are trimmed. At 708, the remaining sample is used to compute the maximum likelihood estimate of the intersection size.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

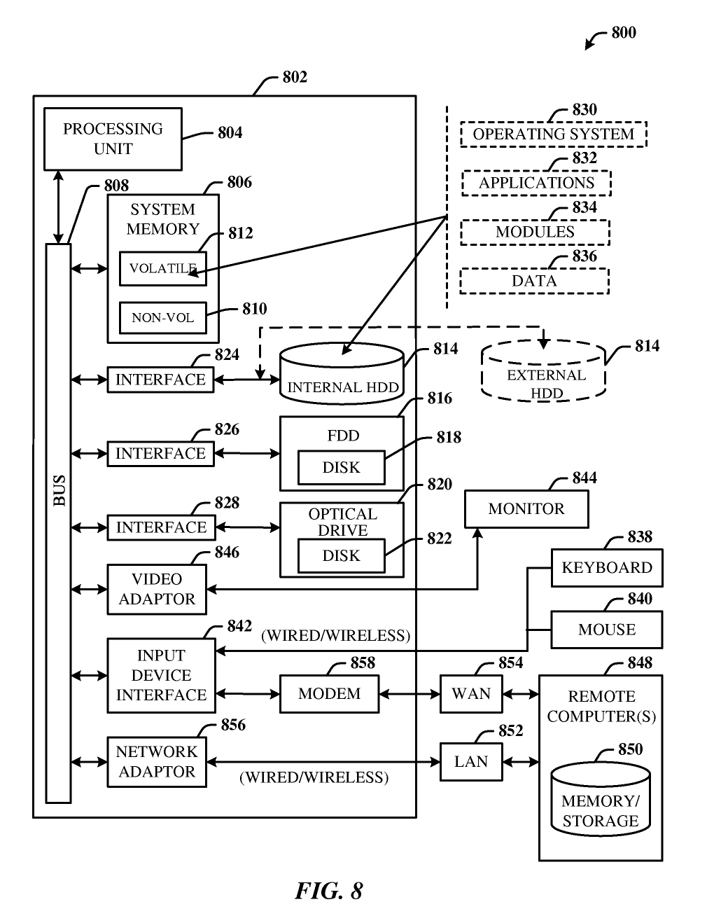

Referring now to FIG. 8, there is illustrated a block diagram of a computing system 800 operable to execute multi-keyword queries according to the disclosed architecture. In order to provide additional context for various aspects thereof, FIG. 8 and the following discussion are intended to provide a brief, general description of a suitable computing system 800 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 8, the exemplary computing system 800 for implementing various aspects includes a computer 802 having a processing unit 804, a system memory 806 and a system bus 808. The system bus 808 provides an interface for system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 can include non-volatile memory (NON-VOL) 810 and/or volatile memory 812 (e.g., random access memory (RAM)). A basic input/output system (BIOS) can be stored in the non-volatile memory 810 (e.g., ROM, EPROM, EEPROM, etc.), which BIOS contains the basic routines that help to transfer information between elements within the computer 802, such as during start-up. The volatile memory 812 can also include a high-speed RAM such as static RAM for caching data.

The computer 802 further includes an internal hard disk drive (HDD) 814 (e.g., EIDE, SATA), which internal HDD 814 may also be configured for external use in a suitable chassis, a magnetic floppy disk drive (FDD) 816, (e.g., to read from or write to a removable diskette 818) and an optical disk drive 820, (e.g., reading a CD-ROM disk 822 or, to read from or write to other high capacity optical media such as a DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 812, including an operating system 830, one or more application programs 832, other program modules 834, and program data 836. The operating system 830, one or more application programs 832, other program modules 834, and/or program data 836 can include the cost component 102, indexing component 104, query optimizer and engine 106, and main index structures (200 and 208). Moreover, the computing system 800 can be a network-based server system that hosts the algorithms, methods, and components described herein.

All or portions of the operating system, applications, modules, and/or data can also be cached in the volatile memory 812. It is to be appreciated that the disclosed architecture can be implemented with various commercially available operating systems or combinations of operating systems.

A user can enter commands and information into the computer 802 through one or more wire/wireless input devices, for example, a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, etc.

A monitor 844 or other type of display device is also connected to the system bus 808 via an interface, such as a video adaptor 846. In addition to the monitor 844, a computer typically includes other peripheral output devices (not shown), such as speakers, printers, etc.

The computer 802 may operate in a networked environment using logical connections via wire and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, is connected to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for query processing, comprising:
a cost component for computing a cost associated with processing a query, the cost relative to a threshold; and
an indexing component for materializing a multi-keyword index structure when the cost exceeds the threshold.

2. The system of claim 1, wherein the cost component and index component are part of an information retrieval system in which the query is being processed.

3. The system of claim 1, wherein the multi-keyword index structure is materialized in addition to a single keyword index structure.

4. The system of claim 1, wherein the cost is expressed as a combination of a cost of disk seeks to a beginning of a posting list and a cost of scanning of the posting list.

5. The system of claim 1, wherein size of the index structure is based on frequency distribution of natural language text.

6. The system of claim 1, wherein the query is processed according to an ID-intersection access method or a post-filtering access method.

7. The system of claim 1, wherein the cost component employs a cost model that computes a measure of overhead of the query.

8. The system of claim 7, wherein the indexing component limits overhead of the query, as calculated by the cost model.

9. The system of claim 1, wherein the index structure materialized by the indexing component includes a match list that points to an inverted index containing postings of items that match keywords.

10. The system of claim 1, wherein the indexing component employs a probabilistic algorithm that estimates intersection sizes in the index structure that can be stored in memory.

11. A computer-implemented method of processing a query, comprising:
creating an additional index structure of multiple keywords relative to a single keyword inverted index;
computing a cost associated with processing a query;
comparing the cost to a threshold value; and
processing the query using the index structure when the cost violates the threshold value.

12. The method of claim 11, further comprising discovering which combinations of the multiple keywords of the index structure are relevant and obtaining size of associated inverted indexes.

13. The method of claim 11, further comprising generating in the index structure a match list that provides a list of keyword combinations for which a corresponding list of posting lists has been materialized.

14. The method of claim 13, further comprising obtaining size information from entries of the match list to determine if processing of the query violates the threshold, and if violated, retrieving top-ranked tuples from corresponding indexes.

15. The method of claim 13, further comprising probabilistically estimating size of intersections between lists of the posting list to maintain a compact representation of relevant inverted indexes in main memory.

16. The method of claim 11, further comprising computing results for the query by selecting inverted indexes in inverse order of associated sizes and intersecting the selected inverted indexes.

17. The method of claim 11, further comprising categorizing the keywords according to frequency and materializing inverted indexes based on the frequency.

18. The method of claim 11, further comprising generating keyword entries in a match list as a function of occurrences of the keywords in documents to be searched.

19. The method of claim 11, further comprising compressing the index structure by augmenting a posting with a field that indicates presence of high-frequency keywords in a document to which the posting refers.

20. A computer-implemented system, comprising:
computer-implemented means for creating an additional index structure of multiple keywords relative to a single keyword inverted index;
computer-implemented means for computing a cost associated with a query;
computer-implemented means for comparing the cost to a threshold value; and
computer-implemented means for processing the query using the index structure when the cost exceeds the threshold value.
